(19) United States
(12) Patent Application Publication
(10) Pub. No.: US 2024/0359464 A1
(43) Pub. Date: Oct. 31, 2024

(54) INK-REPELLENT MEMBER AND INK JET HEAD

(71) Applicant: CANON KABUSHIKI KAISHA, Tokyo (JP)

(72) Inventors: TADAHIRO MIMURA, Kanagawa (JP); JUNRI ISHIKURA, Tokyo (JP); YOHEI MIYAUCHI, Tokyo (JP); KOJI SASAKI, Chiba (JP)

(21) Appl. No.: 18/627,634

(22) Filed: Apr. 5, 2024

(30) Foreign Application Priority Data
Apr. 27, 2023 (JP) 2023-073854
Mar. 21, 2024 (JP) 2024-045268

(51) Int. Cl. B41J 2/14; B41J 2/16; C04B 41/00; C04B 41/48; C04B 41/83

(52) U.S. Cl. CPC B41J 2/1433; B41J 2/162; B41J 2/164; C04B 41/009; C04B 41/4846; C04B 41/83

(57) ABSTRACT

Provided is an ink-repellent member including an underlying portion containing at least one of a silicon oxide and a tantalum oxide, the underlying portion having a fluorine compound bonded to a surface thereof, wherein, when a static contact angle and a receding contact angle of the surface after the ink-repellent member is subjected to the following immersion treatment are represented by θ and θr, respectively, the θ is 100° or more and θ−θr is less than 20°: (Immersion Treatment) (1) a test piece including the surface is cut out of the ink-repellent member, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

### BACKGROUND OF THE INVENTION

### Field of the Invention

The present invention relates to an ink-repellent member and an ink jet head.

### Description of the Related Art

As a head of an ink jet recording apparatus that ejects an ink from a nozzle, there have been known a bubble jet (trademark) head that instantaneously vaporizes an ink through use of a heater to fly droplets and a piezo jet head that flies an ink through use of a piezoelectric element.

When an ink adheres to an ink ejection surface (nozzle plate surface) to form a residue in such ink jet head, ink liquid droplets ejected from the nozzle are influenced, and the ejection directions of the ink droplets may be varied. The variation of the ejection directions causes a reduction in printing quality because it becomes difficult to allow the ink droplets to land at predetermined positions of a recording medium.

In view of the foregoing, there has been proposed that a water-repellent function be imparted to the ink ejection surface. For example, it has been known that an ink-repellent film is formed by arranging an underlying film made of an inorganic oxide on the ink ejection surface, and chemically bonding a fluorine-containing silane coupling agent thereto (Japanese Patent Application Laid-Open No. 2015-3483). The formation of the ink-repellent film suppresses the ink from wetting and spreading on the ink ejection surface, and hence the ink can be easily wiped off with a wiping member or the like even when adhering to the surface. As a result, the variation of the ejection directions of the droplets is suppressed to enhance straightness, with the result that the landing position accuracy to a recording medium is improved to improve printing quality.

A general aqueous ink is alkaline, and hence such ink-repellent film has been required to maintain its ink repellency (ink resistance) when being brought into contact with an alkaline ink having a high pH.

As described in Japanese Patent Application Laid-Open No. 2015-3483, when the ink-repellent film is formed by bonding the fluorine-containing silane coupling agent, an ink-repellent agent is generally uniformly applied to the underlying film for the purpose of enhancing the uniformity of the ink-repellent film.

As a result of the application, the exposure of the underlying film having insufficient alkali resistance can be prevented, and hence the ink repellency can be held even when the ink ejection surface is brought into contact with the alkaline ink.

However, there has been such a problem as described below. When the wettability of the ink-repellent agent with respect to the underlying film is not sufficient, the underlying film repels the ink-repellent agent, or molecules of the ink-repellent agent are aggregated, with the result that gap portions of the ink-repellent film may be formed on the surface of the underlying film. As a result, the underlying film having insufficient alkali resistance is exposed, and is liable to be dissolved through its contact with the alkaline ink, and hence the ink repellency is reduced.

### SUMMARY OF THE INVENTION

According to one aspect of the present invention, there is provided an ink-repellent member including an underlying portion containing at least one of a silicon oxide and a tantalum oxide, the underlying portion having a fluorine compound bonded to a surface thereof, wherein, when a static contact angle and a receding contact angle of the surface after the ink-repellent member is subjected to the following immersion treatment are represented by θ and θr, respectively, the θ is 100° or more and θ−θr is less than 20°: (Immersion Treatment) (1) a test piece including the surface is cut out of the ink-repellent member, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

In addition, according to another aspect of the present invention, there is provided an ink jet head having an ink ejection surface including an underlying portion containing at least one of a silicon oxide and a tantalum oxide, the underlying portion having a fluorine compound bonded to a surface thereof, wherein, when a static contact angle and a receding contact angle of the surface after the ink jet head is subjected to the following immersion treatment are represented by θ and θr, respectively, the θ is 100° or more and θ−θr is less than 20°: (Immersion Treatment) (1) a test piece including the surface is cut out of the ink jet head, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

In addition, according to another aspect of the present invention, there is provided an ink ejection apparatus including the above-mentioned ink jet head. In addition, according to another aspect of the present invention, there is provided a method of producing an article including ejecting a liquid through use of the above-mentioned ink jet head, wherein the liquid is an ink containing a functional material for forming one of a functional thin film and a functional element.

In addition, according to another aspect of the present invention, there can be provided an ink-repellent member including an underlying portion having a surface and containing an inorganic oxide, wherein, when a static contact angle and a receding contact angle of the surface after the ink-repellent member is subjected to the following immersion treatment are represented by θ and θr, respectively, the θ is 100° or more and θ−θr is less than 20°: (Immersion Treatment) (1) a test piece including the surface is cut out of the ink-repellent member, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

Further features of the present invention will become apparent from the following description of exemplary embodiments with reference to the attached drawings.

### BRIEF DESCRIPTION OF THE DRAWINGS

FIG. 1A is a schematic perspective view for illustrating a part of the configuration example of an ink jet head according to the present invention.

FIG. 1B is a top view for illustrating a part of the configuration example of the ink jet head according to the present invention.

FIG. 2A is a schematic view for illustrating the application state of a fluorine compound on an underlying film in an ink-repellent member in the related art.

FIG. 2B is a schematic view for illustrating the surface of the ink-repellent member after the formation of a Si—O—Si bond in the related art.

FIG. 3A is a schematic view for illustrating the application state of a fluorine compound on an underlying film having no fluorine compound bonded thereto in an ink-repellent member according to the present invention.

FIG. 3B is a schematic view for illustrating the surface of the ink-repellent member after the formation of a Si—O—Si bond according to the present invention.

FIG. 4 is a view for illustrating a contact angle and a contact radius in the present invention.

### DESCRIPTION OF THE EMBODIMENTS

The description “XX or more and YY or less” or “XX to YY” representing a numerical range means a numerical range including a lower limit and an upper limit that are end points unless otherwise stated.

When the numerical ranges are described in stages, the upper limits and lower limits of the respective numerical ranges may be arbitrarily combined.

Embodiments of the present invention are described below, but the present invention is not limited to these embodiments.

### <Ink-Repellent Member>

An ink-repellent member according to the present invention is an ink-repellent member including an underlying portion containing at least one of a silicon oxide and a tantalum oxide, the underlying portion having a fluorine compound bonded to a surface thereof, wherein, when a static contact angle and a receding contact angle of the surface after the ink-repellent member is subjected to the following immersion treatment are represented by θ and θr, respectively, the θ is 100° or more and θ−θr is less than 20°: (Immersion Treatment) (1) a test piece including the surface is cut out of the ink-repellent member, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

In addition, the ink-repellent member according to the present invention is an ink-repellent member including an underlying portion having a surface and containing an inorganic oxide, wherein, when a static contact angle and a receding contact angle of the surface after the ink-repellent member is subjected to the following immersion treatment are represented by θ and θr, respectively, the θ is 100° or more and θ−θr is less than 20°: (Immersion Treatment) (1) a test piece including the surface is cut out of the ink-repellent member, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

The ink-repellent member is a member including an ink-repellent film, and may be used as various devices each preferably having ink repellency, for example, a device to which an ink may adhere such as an ink jet head and a machine using an ink, members of the devices, and the like. As used herein, the ink-repellent film refers to a film formed of a fluorine compound.

The ink-repellent member may or may not include a base material. When the ink-repellent member includes a base material, an underlying portion may be arranged on the base material of the ink-repellent member.

When the ink-repellent member is an ink jet head, a flow path substrate of the ink jet head may be used as the base material of the ink-repellent member. Silicon is suitable as a material to be used for the base material, but silicon carbide, silicon nitride, various glasses, such as quartz glass and borosilicate glass, various ceramics, such as alumina and gallium arsenide, and resins such as polyimide may each be used as the material except silicon.

### (Underlying Portion)

The underlying portion in the present invention is preferably a film (underlying film) containing an inorganic oxide. An underlying portion having no fluorine compound bonded thereto has a hydroxy group (—OH) on the surface thereof and hence can form a chemical bond with a fluorine compound having a reactive silyl group (fluorine-containing silane coupling agent). Through the formation of the chemical bond, the adhesiveness between the underlying portion and the fluorine compound serving as an ink-repellent agent can be improved.

Here, the use of an underlying film containing a resin as a main material is also known. However, such underlying film is soft and hence may be subjected to a frictional force through the operation of wiping off an ink adhering to a head with a wipe. As a result, the water-repellent function of the film may be reduced. In the present invention, a hard film containing an inorganic oxide is used as the underlying portion, and is hence advantageous for a frictional force. Oxides, such as silicon oxide, zirconia, alumina, titania, hafnia, tantalum oxide, cerium oxide, tungsten oxide, niobium oxide, yttrium oxide, indium oxide, and strontium oxide, may each be used as the inorganic oxide. In the present invention, the underlying film preferably contains a silicon oxide from the viewpoint that such film easily forms a Si—O—Si bond with the fluorine compound (fluorine-containing silane coupling agent). In addition, the underlying film preferably contains a tantalum oxide from the viewpoint that such film is excellent in alkali resistance.

SiO₂ is preferably incorporated as the silicon oxide from the viewpoint that the content of hydroxy groups serving as reaction sites in the surface is high. However, silicon oxides having different oxidation numbers (SiO_{α}, where α represents an integer of 1 or more) may be used, and a mixture thereof may also be used.

Examples of a method of forming the silicon oxide include a formation method including oxidation treatment of silicon that is a flow path substrate or silicon carbide (SiC) formed on silicon with heat, plasma, or UV, and a formation method based on sputtering vapor deposition using a silicon oxide target, an atomic layer deposition (ALD) method, a chemical vapor deposition (CVD) method, or a spin coating method, but the present invention is not particularly limited thereto.

The tantalum oxide preferably contains Ta₂O₅. The method of forming the tantalum oxide is not particularly limited, and the tantalum oxide may be formed by sputtering vapor deposition using an oxide target, an electron beam vapor deposition method, or the like.

When the ink-repellent member includes a base material, the underlying portion may be arranged on the base material. The base material is, for example, a silicon substrate in which an oxide film such as a thermally oxidized film is formed on the surface. When the base material itself is formed so as to contain an inorganic oxide in the surface thereof, the base material itself may be used as the underlying portion.

### (Fluorine Compound)

The fluorine compound to be used in the present invention is a fluorine-containing silane coupling agent and may act as an ink-repellent agent. The fluorine compound is described below.

The fluorine compound has a linear main chain structure, and only one of the both ends of its main chain is chemically bonded to a hydroxy group on the surface of the underlying portion. Specifically, when the underlying portion contains a silicon oxide, the fluorine compound is chemically bonded to the surface of the underlying portion via a Si—O—Si bond. In addition, when the underlying portion contains a tantalum oxide, the fluorine compound is chemically bonded to the surface of the underlying portion via a Ta—O—Si bond.

In order to form a Si—O—Si bond or a Ta—O—Si bond, the fluorine compound to be used for producing an ink-repellent member or an ink jet head has at least one reactive silyl group represented by the following formula (1). When the fluorine compound has the reactive silyl group only at one of its ends, a reaction between molecules of the fluorine compound can be suppressed.

*—Si(Y¹)ₙ(OR)ₘ (1)

In the formula (1), “n” and “m” each represent an integer of from 0 to 3 and n+m=3 is satisfied, Y's each independently represent any one of an alkyl group, a chloro group, and a bromo group, Rs each independently represent a hydrogen atom or an alkyl group, and “*” represents a bonding position in the fluorine compound. When n=3 and m=0 are satisfied, at least one of Y's may represent a chloro group or a bromo group.

In addition, the fluorine compound preferably has a perfluoromethyl group (structure) at the other end. The perfluoromethyl structure has small surface free energy and can express high ink repellency.

The main chain structure preferably has a perfluoropolyether (hereinafter sometimes referred to as “PFPE”) structure from the viewpoints of ink repellency and sliding resistance.

That is, the preferred structure of the fluorine compound to be used for producing an ink-repellent member or an ink jet head may be represented by the following formula (9):

F₃C-R²-R¹ (9)

in the formula (9), R¹ represents the reactive silyl group represented by the formula (1), and R² represents a structure having a perfluoropolyether structure.

The fluorine compound preferably has, as the PFPE structure, at least one of a structure represented by the following formula (2), a structure represented by the following formula (3), a structure represented by the following formula (4), and a structure represented by the following formula (5). The fluorine compound having, as the PFPE structure, at least one of a structure represented by the following formula (2), a structure represented by the following formula (3), a structure represented by the following formula (4), and a structure represented by the following formula (5) is commercially easily available.

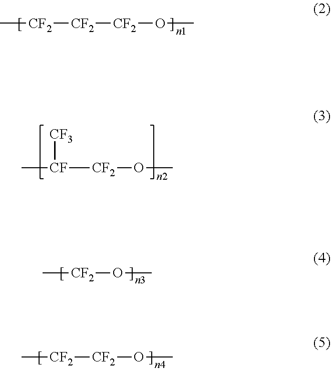

In the formulae (2), (3), (4), and (5), n1, n2, n3, and n4 each independently represent an integer of 1 or more.

Preferred specific examples of the fluorine compound include a compound represented by the following formula (6), a compound represented by the following formula (7), and a compound represented by the following formula (8):

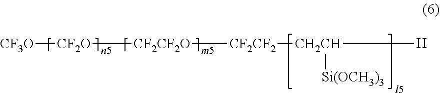

in the formula (6), n5, m5, and 15 each independently represent an integer of 1 or more;

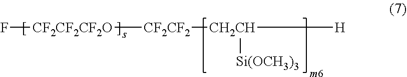

in the formula (7), “s” and m6 each independently represent an integer of 1 or more; and

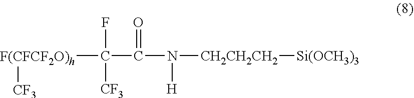

in the formula (8), “h” represents an integer of 1 or more.

The fluorine compound contained in the ink-repellent member or the ink jet head is preferably a fluorine compound that has a main chain having a perfluoropolyether structure and has a perfluoromethyl group at its end.

That is, the preferred structure of the fluorine compound in a state in which the fluorine compound is chemically bonded to the surface of the underlying portion via a Si—O—Si bond or a Ta—O—Si bond may be represented by the following formula (10):

F₃C-R²-R³—* (10)

in the formula (10), R² represents a structure having a perfluoropolyether structure, R³ represents a Si—O bond, and the fluorine compound represented by the formula (10) is chemically bonded to the surface of the underlying portion via a Si—O—Si bond or a Ta—O—Si bond containing the Si—O bond, and “*” represents a bonding position with respect to a silicon atom or a tantalum atom.

### (Fluoropolymer)

The inventors of the present invention have made investigations repeatedly in order to obtain an ink-repellent member that is excellent in ink repellency even when the wettability of a fluorine compound with respect to an underlying portion having no fluorine compound bonded thereto is not sufficient. As a result, the inventors have found that the above-mentioned object can be achieved by providing the step of forming a thin film of a fluoropolymer on the surface of the underlying portion in the step of forming an ink-repellent film.

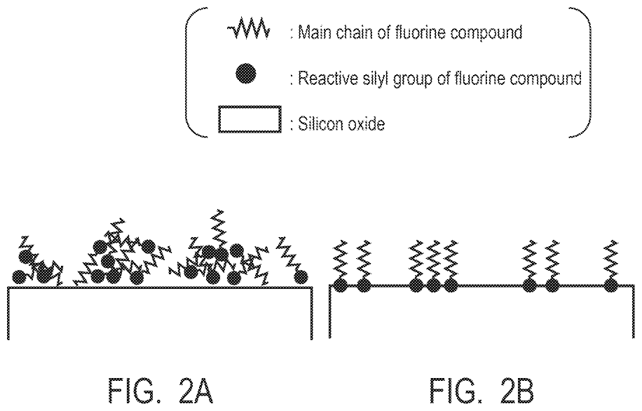

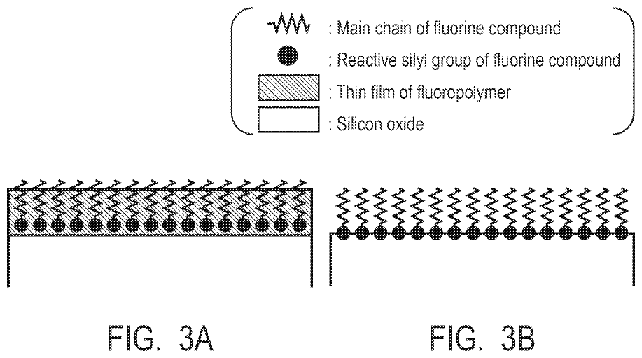

FIG. 2A is a schematic view for illustrating the application state of a fluorine compound on an underlying film in an ink-repellent member in the related art, and FIG. 2B is a schematic view for illustrating the surface of the ink-repellent member after the formation of a Si—O—Si bond in the related art. When the wettability of the fluorine compound with respect to the underlying film is not sufficient, at the time of the application of the fluorine compound to the underlying film, the fluorine compound is repelled or molecules of the fluorine compound are aggregated, and hence the application becomes non-uniform. As a result, the state as illustrated in FIG. 2A is established. Because of this, after the formation of the Si—O—Si bond, gap portions that are not covered with the fluorine compound are liable to be formed. As a result, the state as illustrated in FIG. 2B is established. In this case, portions of the underlying film that have insufficient alkali resistance are liable to be brought into contact with an ink, and the underlying film is dissolved. As a result, the ink resistance is reduced. In view of the foregoing, it is conceived that, when a thin film of a fluoropolymer is formed on the surface of an underlying film having no fluorine compound bonded thereto and then the fluorine compound is applied thereto, the fluorine compound is uniformly dispersed in the thin film of the fluoropolymer to suppress the repelling and the aggregation, and hence the formation of gaps is suppressed. FIG. 3A is a schematic view for illustrating the application state of a fluorine compound on an underlying film having no fluorine compound bonded thereto in an ink-repellent member according to the present invention, and FIG. 3B is a schematic view for illustrating the surface (surface of the underlying portion) of the ink-repellent member in which a fluorine compound is bonded to the surface of the underlying film via a Si—O—Si bond after the establishment of the state of FIG. 3A.

The fluoropolymer may be selected from fluorine materials having high affinities for both the underlying film (inorganic oxide) and the fluorine compound. When the fluorine compound is applied under a state in which the thin film of the fluoropolymer is formed on the underlying film having no fluorine compound bonded thereto, the aggregation of molecules of the fluorine compound can be suppressed. As a result, a Si—O—Si bond or a Ta—O—Si bond can be formed under a state in which the molecules of the fluorine compound are uniformly arranged on the underlying film, and hence an ink-repellent film with few gaps on the surface can be formed.

The fluoropolymer to be used for producing an ink-repellent member or an ink jet head has a main chain having a perfluoropolyether structure and has perfluoromethyl groups (structures) at both of its ends. The fluoropolymer to be used for producing an ink-repellent member or an ink jet head may be represented by, for example, the following formula (11):

F₃C—R₄—CF₃ (11)

in the formula (11), R⁴ represents a structure having a perfluoropolyether structure.

When the fluoropolymer has a perfluoromethyl structure at its end, its affinity for the fluorine compound is enhanced to improve the dispersibility of the fluorine compound.

The fluoropolymer is preferably a fluorine oil having a PFPE structure as a main chain structure from the viewpoint of affinity for the fluorine compound.

The fluorine oil has satisfactory wettability also with respect to the inorganic oxide in the underlying film and has viscosity. Thus, the fluorine oil enables a thin film to be uniformly formed on the underlying film without repelling or the like.

The fluoropolymer to be used for producing an ink-repellent member or an ink jet head preferably has, as the PFPE structure, at least one of the structure represented by the formula (2), the structure represented by the formula (3), the structure represented by the formula (4), and the structure represented by the formula (5). Further, the fluoropolymer to be used for producing an ink-repellent member or an ink jet head preferably has the structure represented by the formula (4) and the structure represented by the formula (5). The fluoropolymer having at least one of the structure represented by the formula (2), the structure represented by the formula (3), the structure represented by the formula (4), and the structure represented by the formula (5) is commercially easily available.

The fluorine compound and the fluoropolymer preferably have the same PFPE structure from the viewpoint of affinity.

The thin film of the fluoropolymer to be used for producing an ink-repellent member or an ink jet head is preferably thicker than the molecular chain length of the fluorine compound and preferably has a thickness of 100 nm or more from the viewpoint of enhancing the suppressing effect on the aggregation of the molecules of the fluorine compound on the surface of the underlying film. The film thickness may be appropriately selected in accordance with application processes and conditions. When the fluoropolymer is directly applied, the fluoropolymer may be applied by vacuum vapor deposition or heating vapor deposition. In this case, the film thickness may be controlled by selecting a vacuum degree, a vapor deposition temperature, and a vapor deposition amount. In addition, a coating film may be formed by applying a fluoropolymer solution by a spray coating method, a spin coating method, a dip coating method, or the like and drying a solvent. In this case, the film thickness may be controlled by selecting a solution concentration, a coating time, a rotation speed, or the like.

### <Method of Producing Ink-Repellent Member>

A method of producing an ink-repellent member according to the present invention is a method of producing an ink-repellent member including an underlying portion containing at least one of a silicon oxide and a tantalum oxide, the underlying portion having a fluorine compound bonded to a surface thereof, wherein the method includes the following steps (1) to (3):
(1) forming a hydroxy group on the surface of an underlying portion having no fluorine compound bonded thereto;
(2) forming a thin film containing a fluoropolymer that has a main chain having a perfluoropolyether structure and has perfluoromethyl structures at both of its ends on the surface of the underlying portion having no fluorine compound bonded thereto, on which the hydroxy group is formed in the step (1); and
(3) applying a fluorine compound having a reactive silyl group represented by the following formula (1) onto the thin film formed in the step (2), followed by dehydration condensation.

*—Si(Y¹)ₙ(OR)ₘ (1)

in the formula (1), “n” and “m” each represent an integer of from 0 to 3 and n+m=3 is satisfied, Y¹s each independently represent any one of an alkyl group, a chloro group, and a bromo group, Rs each independently represent a hydrogen atom or an alkyl group, and “*” represents a bonding position in the fluorine compound.

### (Method of Forming Ink-Repellent Film)

An example of a method of forming an ink-repellent film by bonding a fluorine compound to an underlying portion is described. A method of forming an ink-repellent member and an ink jet head each including an underlying portion containing a silicon oxide, the underlying portion having a fluorine compound chemically bonded to a surface thereof via a Si—O—Si bond, may be performed by silane coupling treatment.

First, an underlying film containing a silicon oxide is formed on a silicon substrate to form a silanol group including a hydroxy group on the surface.

Examples of a method of forming the underlying film containing a silicon oxide include a formation method including oxidation treatment of silicon that is a flow path substrate or silicon carbide (SiC) formed on silicon with heat, plasma, UV, or the like, and a formation method based on sputtering vapor deposition using a silicon oxide target, an atomic layer deposition (ALD) method, a chemical vapor deposition (CVD) method, or a spin coating method, but the present invention is not particularly limited thereto.

An example of a method of forming a silanol group including a hydroxy group (—OH) on the surface of the underlying film containing a silicon oxide is a method of forming a surface hydroxy group (—OH) by subjecting the surface of the underlying film to a reaction with moisture.

Next, a fluoropolymer is applied to the surface of the underlying film having the silanol group formed thereon.

A method for the application is not particularly limited. For example, a material may be directly applied by a vapor deposition method, such as a vacuum vapor deposition method or a heating vapor deposition method. Alternatively, a coating film may be formed by applying a solution diluted with a fluorine solvent by a spray coating method, a spin coating method, a dip coating method, or the like and drying a solvent.

Next, a fluorine compound is applied to the surface of the underlying portion on which a thin film containing the fluoropolymer is formed.

A method for the application is not particularly limited. For example, a material may be directly applied by a vapor deposition method, such as a vacuum vapor deposition method or a heating vapor deposition method. Alternatively, a method including applying a solution diluted with a fluorine solvent by a spray coating method, a spin coating method, a dip coating method, or the like and drying a solvent may be adopted.

Subsequently, an alkoxysilyl group or a halogenated silyl group at the end of the fluorine compound may be hydrolyzed and converted to a silanol group.

Then, a dehydration condensation reaction with the hydroxy group formed on the underlying film is performed to form a Si—O—Si bond.

The hydrolysis is caused by exposure to moisture and is also caused by adsorbed water present on the surface of the underlying film, but may be accelerated under a high-humidity environment (e.g., from 60% RH to 100% RH).

In addition, the dehydration condensation reaction occurs even at room temperature (e.g., 23° C.), but may be accelerated at high temperature (e.g., from 60° C. to 150° C.).

A reaction time for the hydrolysis and the dehydration condensation reaction may be appropriately selected in accordance with humidity and temperature. For example, under the conditions of 60° C. and 80% RH, the reaction time is about 2 hours in total.

Subsequently, cleaning is performed to remove the non-bonded fluorine compound and the fluoropolymer.

A method for the cleaning is not particularly limited, but for example, it is only required that the resultant be immersed in a fluorine solvent serving as a cleaning solvent that is compatible with the fluorine compound. In this case, the fluorine solvent may be heated or an ultrasonic wave may be applied thereto as required.

In the case of using an underlying film containing a tantalum oxide, a Ta—O—Si bond can be formed between the hydroxy group on the surface of the underlying film and the reactive silyl group of the fluorine compound by performing silane coupling treatment in the same manner as in the case of using the above-mentioned underlying film containing the silicon oxide. In addition, a method of forming the tantalum oxide is not particularly limited, and the tantalum oxide may be formed by sputtering vapor deposition using an oxide target, an electron beam vapor deposition method, or the like.

### <Ink Jet Head>

An example of the ink-repellent member is an ink jet head.

An ink jet head according to the present invention can be mounted on an ink ejection apparatus, and an ink ejection apparatus according to the present invention is an ink ejection apparatus characterized by including the ink jet head according to the present invention.

The ink jet head according to the present invention is an ink jet head having an ink ejection surface including an underlying portion containing at least one of a silicon oxide and a tantalum oxide, the underlying portion having a fluorine compound bonded to a surface thereof, wherein, when a static contact angle and a receding contact angle of the surface after the ink jet head is subjected to the following immersion treatment are represented by θ and θr, respectively, the θ is 100° or more and θ−θr is less than 20°: (Immersion Treatment) (1) a test piece including the surface is cut out of the ink jet head, is placed in a sealable container containing an aqueous solution having a pH of 11, and is immersed in the aqueous solution so that the test piece is entirely immersed therein; and (2) the test piece is maintained at 70° C. for 170 hours under a sealed state after the immersion in (1).

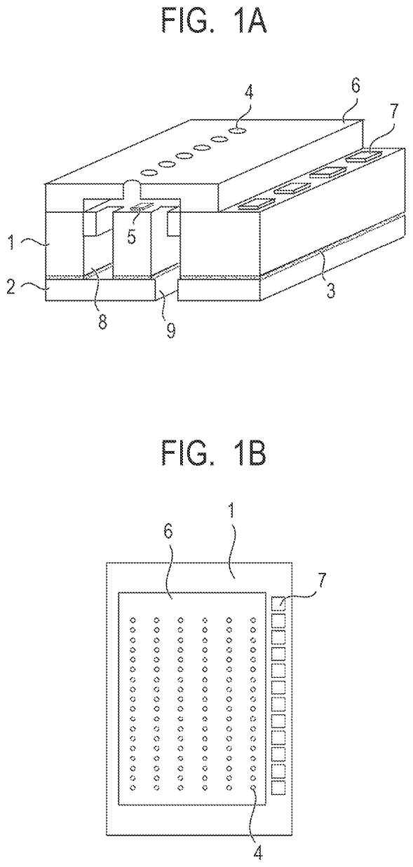

FIG. 1A is a schematic perspective view for illustrating a part of the configuration example of an ink jet head in an embodiment of the present invention. A first flow path substrate 1 and a second flow path substrate 2, which are joined to each other with an adhesive 3, and a third flow path substrate 6 including ejection orifices 4 are joined to each other.

The surface of the first flow path substrate 1 has energy-generating elements 5, in particular, electrothermal converting elements or piezoelectric elements for ejecting an ink, and may also include wiring or the like (not shown) for driving the energy-generating elements 5. The energy-generating elements 5 are formed on the first flow path substrate 1 so as to correspond to the positions of the ejection orifices 4. The third flow path substrate 6 and electrodes 7 are formed on the first flow path substrate 1. An ink passes through a second through-flow path 9 and a first through-flow path 8 formed in the second flow path substrate 2 and the first flow path substrate 1, respectively, and is given ejection energy by the energy-generating elements 5 to be jetted from the ejection orifices 4. FIG. 1B is a top view of the first flow path substrate 1 and the third flow path substrate 6.

The ink-repellent film in the present invention is formed on the surface of the third flow path substrate 6 on the side opposite to the surface joined to the first flow path substrate 1. That is, an ink ejection surface including an underlying portion containing at least one of a silicon oxide and a tantalum oxide, the underlying portion having a fluorine compound bonded to a surface thereof, is formed on the above-mentioned surface of the third flow path substrate 6.

Silicon is suitable as a material for the flow path substrates, but silicon carbide, silicon nitride, various glasses, such as quartz glass and borosilicate glass, various ceramics, such as alumina and gallium arsenide, and resins such as polyimide may each be used as the material except silicon.

Examples of a method of forming the first through-flow path 8 and the second through-flow path 9 in the first flow path substrate 1 and the second flow path substrate 2 include dry etching, wet etching, and laser processing. In addition, in order to regulate the height of each flow path in a sectional direction, the member may be thinned by polishing using backgrinding or chemical mechanical polishing (CMP).

<Method of producing Ink Jet Head>

A method of producing an ink jet head according to the present invention is a method of producing an ink jet head having an ink ejection surface including an underlying portion containing at least one of a silicon oxide and a tantalum oxide, the underlying portion having a fluorine compound bonded to a surface thereof, wherein the method includes the following steps (1) to (3):
(1) forming a hydroxy group on the surface of an underlying portion having no fluorine compound bonded thereto;
(2) forming a thin film containing a fluoropolymer that has a main chain having a perfluoropolyether structure and has perfluoromethyl structures at both of its ends on the surface of the underlying portion having no fluorine compound bonded thereto, on which the hydroxy group is formed in the step (1); and
(3) applying a fluorine compound having a reactive silyl group represented by the following formula (1) to the thin film formed in the step (2), followed by dehydration condensation.

*—Si(Y¹)ₙ(OR)ₘ (1)

in the formula (1), “n” and “m” each represent an integer of from 0 to 3 and n+m=3 is satisfied, Y¹s each independently represent any one of an alkyl group, a chloro group, and a bromo group, Rs each independently represent a hydrogen atom or an alkyl group, and “*” represents a bonding position in the fluorine compound.

### <Contact Angle>

The ink-repellent member or the ink jet head in the present invention is characterized in that, when the static contact angle and receding contact angle of the surface or ink ejection surface (surface of the underlying portion) of the ink-repellent member or the ink jet head after the following immersion treatment is performed are represented by θ and θr, respectively, the θ is 100° or more and θ−θr is less than 20°.

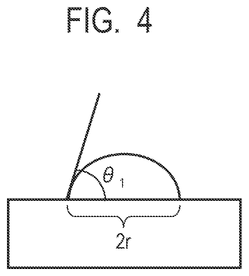

The angles formed by dropped droplets and a solid surface when the droplets are dropped onto the solid surface are called contact angles. Of those, the static contact angle refers to an angle formed by a liquid surface and the solid surface when the droplet is at rest on the solid. In addition, the receding contact angle refers to, for example, a contact angle formed on the back side with respect to the movement direction of a droplet, when the liquid moves in a certain direction. The static contact angle and the receding contact angle may be determined from the image of a droplet by calculating the contact angles through use of image analysis. The static contact angle may be determined by, for example, a θ/2 method or a tangent method. The receding contact angle may be determined by, for example, an extension/contraction method or a sliding method. In addition, the receding contact angle may be determined by continuously measuring a contact radius at predetermined time intervals after the landing of a droplet by a sessile drop method. In the present invention, a test piece including the surface or the ink ejection surface (surface of the underlying portion) from which the static contact angle or the receding contact angle is to be determined is taken from the ink-repellent member or the ink jet head, and the test piece may be measured for a static contact angle or a receding contact angle. FIG. 4 is a view for illustrating a contact angle θ₁ and a contact radius “r”.

The ink repellency of the ink-repellent member or the ink jet head may be evaluated by the static contact angle of the surface or the ink ejection surface (surface of the underlying portion) thereof or the difference between the static contact angle and the receding contact angle. When the static contact angle of the surface or the ink ejection surface (surface of the underlying portion) is 100° or more, the water repellency is high, and an ink can be easily removed. In this case, it can be determined that the ink repellency is high. In addition, when the difference between the static contact angle and the receding contact angle is small, it can be determined that the ink repellency of the surface or the ink ejection surface is homogeneously kept. When a large number of hydrophilic portions are exposed on the surface or the ink ejection surface, and the hydrophilic portions and hydrophobic (ink-repellent) portions coexist (when the surface is not homogeneous), the receding contact angle may become small through a pinning effect, and the difference between the static contact angle and the receding contact angle may be increased.

In this specification, the static contact angle and the receding contact angle of the surface or the ink ejection surface (surface of the underlying portion) of the ink-repellent member or the ink jet head after the following immersion treatment are represented by θ and θr, respectively. When the θ is 100° or more and θ−θr is less than 20° after the immersion treatment, it can be determined that the ink repellency is high and homogeneously kept even with respect to an alkaline ink having a high pH. The θ−θr is preferably less than 15°, more preferably less than 12°.

### (Immersion Treatment)

(1) A test piece including the surface or the ink ejection surface (surface of the underlying portion) is cut out of the ink-repellent member or the ink jet head, is placed in a sealable container containing an aqueous solution having a pH of 11, and is immersed in the aqueous solution so that the test piece is entirely immersed therein.
(2) The test piece is maintained at 70° C. for 170 hours under a sealed state after the immersion in (1).

### (Method of Producing Article Using Ink-Repellent Member)

A method of producing an article according to one embodiment of the present invention is a method of producing an article including ejecting a liquid through use of the above-mentioned ink-repellent member (e.g., an ink jet head), wherein the liquid is an ink containing a functional material for forming one of a functional thin film and a functional element.

### EXAMPLES

The present invention is specifically described below by way of Examples. The present invention is not limited to the following Examples.

### Example 1

A Φ3-inch silicon substrate was heated at 900° C. under an oxygen atmosphere to form a thermally oxidized film containing SiO₂ as an underlying film on the surface.

Next, through use of FP-1 described below as a fluoropolymer, an FP-1 solution was applied onto the silicon substrate having the underlying film formed thereon by spin coating so as to have a film thickness of 80 nm, and a solvent was volatilized. Thus, a thin film of FP-1 was formed. The FP-1 solution was prepared by dissolving FP-1 in a fluorine solvent (Novec 7300, manufactured by 3M Company) at a concentration of 5% by weight.

Next, the silicon substrate having the thin film of FP-1 formed thereon was placed in a vacuum vapor deposition device, and FC-1 described below was applied as a fluorine compound to the surface having the FP-1 formed thereon by vapor deposition. The vapor deposition was performed by placing 60 mg of FC-1 in a state of being impregnated into steel wool in a Cu container and resistively heating the Cu container.

Subsequently, the silicon substrate having FC-1 deposited from the vapor thereon was placed in a constant-temperature and constant-humidity device, and was allowed to stand still for 3 hours under an environment of 60° C. and 80% RH.

The removed silicon substrate was maintained under a state of being immersed in a fluorine solvent (Novec 7300, manufactured by 3M company) for 20 seconds, and the surface was cleaned. The cleaning was repeated three times through use of a separately prepared fluorine solvent. After that, the resultant was further immersed in a fluorine solvent, and ultrasonic cleaning was performed.

After the cleaning, the fluorine solvent was removed by air drying.

Thus, an ink-repellent member 1 including an ink-repellent film (including the underlying film having a fluorine compound bonded to a surface thereof) was produced.

FC-1: compound represented by the formula (6) having a number average molecular weight of 5,000 (X-71-195, manufactured by Shin-Etsu Chemical Co., Ltd.)

FP-1: Fomblin M03 having a main chain structure having the structure represented by the formula (4) and the structure represented by the formula (5) (Fomblin M series, manufactured by Solvay Specialty Polymers Japan K.K.)

### Examples 2 to 4

Ink-repellent members 2 to 4 according to Examples 2 to 4 were each produced in the same manner as in Example 1 except that the material types of the fluorine compounds and the material types and the film thicknesses of the fluoropolymers were changed to those shown in Table 1.

FP-2 used as the fluorine polymer in Example 4 is described below.

FP-2: Krytox GPL Oil 103 (manufactured by Chemours) having a main chain structure having the structure represented by the formula (3)

### Example 5

Ta₂O₅ was formed on a Φ3-inch silicon substrate by electron beam vapor deposition, and was used as an underlying film. When the underlying film was formed, the film thickness of the underlying film was observed with a crystal oscillator, and vapor deposition was finished when the film thickness reached 100 nm (calculated as a refractive index of 2.165). An ink-repellent member 5 was produced in the same manner as in Example 1 except that: the underlying film was changed; and the material type of the fluorine compound and the material type and the film thickness of the fluoropolymer were changed to those shown in Table 1.

### Comparative Example 1

An ink-repellent member 6 according to Comparative Example 1 was produced in the same manner as in Example 1 except that the fluoropolymer was not used.

### Comparative Example 2

An ink-repellent member 7 according to Comparative Example 2 was produced in the same manner as in Example 5 except that the fluoropolymer was not used.

### (Evaluation Preparation: Ink Immersion Treatment)

The produced ink-repellent members 1 to 7 were subjected to immersion treatment by the following procedure. First, test pieces each having a size of 3 cm×3 cm and a thickness of 1 mm and including the surface (surface of the underlying portion having a fluorine compound bonded thereto) of each of the ink-repellent members were cut out of the ink-repellent members 1 to 7. Then, an aqueous solution (potassium hydroxide) adjusted to a pH of 11 was loaded into a sealable container made of a tetrafluoroethylene/perfluoroalkoxyethylene copolymer resin (PFA). The test pieces were immersed in the aqueous solution so that each of the test pieces was entirely brought into contact with the aqueous solution, and the container was sealed with a lid. The container was placed in an oven under this state, and was heated at 70° C. for 1 week (170 hours). After each of the removed test pieces was sufficiently washed with water so that the aqueous solution was removed, the static contact angle and the receding contact angle of the surface of each of the ink-repellent members 1 to 7 (surface of the underlying portion having the fluorine compound bonded thereto) were measured by a method described in the following section (Evaluation: Contact Angle Measurement).

### (Evaluation: Contact Angle Measurement)

The static contact angle θ and the receding contact angle θr of the surface (surface of the underlying portion having the fluorine compound bonded thereto) of each of the ink-repellent members with respect to pure water after the above-mentioned immersion treatment were measured with a contact angle meter (product name: DM-701, manufactured by Kyowa Interface Science Co., Ltd., analysis software: FAMAS (ver. 3.5.5)). Conditions for the measurement were as described below.
Droplet: 2 μL
Static contact angle θ: the contact angle after one second from the landing of a droplet was defined as a static contact angle θ.
Receding contact angle θr: the angle was calculated by a sessile drop method.

The receding contact angle θr was measured specifically by the following method. The contact angle was measured at 80 points at intervals of 15 seconds after the landing of a droplet. The following calculation was performed in the order from a time of 0 seconds through use of the values of the contact angle and the contact radius (unit: μm) at a certain time calculated from the above-mentioned software, and the following processes (A) and (B) were performed.
(A) When the value of a contact radius at a time “t” is represented by Rₜ and the value of a contact radius after t+90 seconds is represented by R₁₊₉₀, the value “x” of (Rₜ−Rₜ+90)² was calculated.
(B) When the value “x” was 200 or less, the process (A) was performed again, and the contact angle at a time “t” when the value “x” first exceeded 200 was defined as the receding contact angle θr.

### (Evaluation Criteria for θ−θr)

Rank A: θ−θr is less than 12°
Rank B: θ−θr is 12° or more and less than 15°.
Rank C: θ−θr is 15° or more and less than 20°.
Rank D: θ−θr is 20° or more.

In this Example, when the θ is 100° or more and the θ−θr is evaluated to be the rank C or more, it can be said that the ink-repellent member is excellent in ink repellency.

TABLE 1

| | | | | | | After immersion | | |
|---|---|---|---|---|---|---|---|---|
| | | Material | | | | treatment | | |
| | Ink- | for water- | Material | Fluoropolymer | | Static | Receding | |
| | repellent | repellent | type of | | Film | contact | contact | |
| | member | underlying | fluorine | Material | thickness | angle θ | angle θr | θ − θr |
| | No. | film | compound | type | (nm) | (°) | (°) | (°) |
| Example 1 | 1 | SiO₂ | FC-1 | FP-1 | 80 | 108.1 | 91.0 | 17.1 |
| Example 2 | 2 | SiO₂ | FC-1 | FP-1 | 120 | 106.6 | 92.1 | 14.5 |
| Example 3 | 3 | SiO₂ | FC-1 | FP-1 | 390 | 108.6 | 97.4 | 11.2 |
| Example 4 | 4 | SiO₂ | FC-1 | FP-2 | 390 | 105.2 | 92.4 | 12.8 |
| Example 5 | 5 | Ta₂O₅ | FC-1 | FP-1 | 390 | 106.5 | 94.6 | 11.9 |
| Comparative | 6 | SiO₂ | FC-1 | — | — | 108.5 | 87.7 | 20.8 |
| Example 1 | | | | | | | | |
| Comparative | 7 | Ta₂O₅ | FC-1 | — | — | 106.8 | 85.6 | 21.2 |
| Example 2 | | | | | | | | |

The evaluation results of the θ−θr of the ink-repellent members 1 to 7 produced in Examples 1 to 5 and Comparative Examples 1 and 2 are shown in Table 2.

TABLE 2

| | Ink-repellent member No. | Evaluation |
|---|---|---|
| Example 1 | 1 | C |
| Example 2 | 2 | B |
| Example 3 | 3 | A |
| Example 4 | 4 | B |
| Example 5 | 5 | A |
| Comparative Example 1 | 6 | D |
| Comparative Example 2 | 7 | D |

It was understood from Tables 1 and 2 that an ink-repellent member excellent in ink repellency was able to be obtained by Examples according to the present invention.

According to one aspect of the present invention, an ink-repellent member excellent in ink repellency was able to be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-073854, filed Apr. 27, 2023, and Japanese Patent Application No. 2024-045268, filed Mar. 21, 2024, which are hereby incorporated by reference herein in their entirety.

What is claimed is:

1. An ink-repellent member comprising an underlying portion containing at least one of a silicon oxide and a tantalum oxide, the underlying portion having a fluorine compound bonded to a surface thereof,
wherein, when a static contact angle and a receding contact angle of the surface after the ink-repellent member is subjected to the following immersion treatment are represented by θ and θr, respectively, the θ is 100° or more and θ−θr is less than 20°:
(Immersion Treatment)
(1) a test piece including the surface is cut out of the ink-repellent member, is placed in a sealable container containing an aqueous solution having a pH of 11, and is immersed in the aqueous solution so that the test piece is entirely immersed therein; and
(2) the test piece is maintained at 70° C. for 170 hours under a sealed state after the immersion in (1).

2. The ink-repellent member according to claim 1, wherein the θ−θr is less than 15°.

3. The ink-repellent member according to claim 1,
wherein, when the underlying portion contains the silicon oxide, the fluorine compound is bonded to the surface via a Si—O—Si bond, and
wherein, when the underlying portion contains the tantalum oxide, the fluorine compound is bonded to the surface via a Ta—O—Si bond.

4. The ink-repellent member according to claim 1 further comprising a base material, wherein the underlying portion is arranged on the base material.

5. The ink-repellent member according to claim 1, wherein the fluorine compound has a main chain having a perfluoropolyether structure and has a perfluoromethyl group at an end thereof.

6. The ink-repellent member according to claim 1, wherein the fluorine compound has at least one of a structure represented by the following formula (2), a structure represented by the following formula (3), a structure represented by the following formula (4), and a structure represented by the following formula (5): 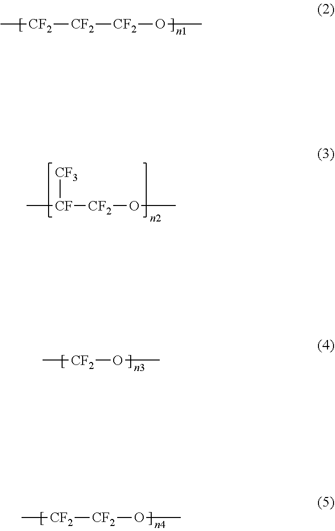
in the formulae (2), (3), (4), and (5), n1, n2, n3, and n4 each independently represent an integer of 1 or more.

7. An ink jet head having an ink ejection surface comprising an underlying portion containing at least one of a silicon oxide and a tantalum oxide, the underlying portion having a fluorine compound bonded to a surface thereof,
wherein, when a static contact angle and a receding contact angle of the surface after the ink jet head is subjected to the following immersion treatment are represented by θ and θr, respectively, the θ is 100° or more and θ−θr is less than 20°:
(Immersion Treatment)
(1) a test piece including the surface is cut out of the ink jet head, is placed in a sealable container containing an aqueous solution having a pH of 11, and is immersed in the aqueous solution so that the test piece is entirely immersed therein; and
(2) the test piece is maintained at 70° C. for 170 hours under a sealed state after the immersion in (1).

8. The ink jet head according to claim 7, wherein the θ−θr is less than 15°.

9. The ink jet head according to claim 7,
wherein, when the underlying portion contains the silicon oxide, the fluorine compound is bonded to the surface via a Si—O—Si bond, and
wherein, when the underlying portion contains the tantalum oxide, the fluorine compound is bonded to the surface via a Ta—O—Si bond.

10. The ink jet head according to claim 7, wherein the fluorine compound has a main chain having a perfluoropolyether structure and has a perfluoromethyl group at an end thereof.

11. The ink jet head according to claim 7, wherein the fluorine compound has at least one of a structure represented by the following formula (2), a structure represented by the following formula (3), a structure represented by the following formula (4), and a structure represented by the following formula (5): 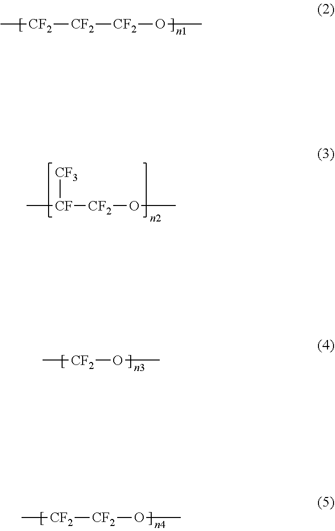
in the formulae (2), (3), (4), and (5), n1, n2, n3, and n4 each independently represent an integer of 1 or more.

12. An ink ejection apparatus comprising the ink jet head of claim 7.

13. An ink-repellent member comprising an underlying portion having a surface and containing an inorganic oxide,
wherein, when a static contact angle and a receding contact angle of the surface after the ink-repellent member is subjected to the following immersion treatment are represented by θ and θr, respectively, the θ is 100° or more and θ−θr is less than 20°:
(Immersion Treatment)
(1) a test piece including the surface is cut out of the ink-repellent member, is placed in a sealable container containing an aqueous solution having a pH of 11, and is immersed in the aqueous solution so that the test piece is entirely immersed therein; and
(2) the test piece is maintained at 70° C. for 170 hours under a sealed state after the immersion in (1).

14. A method of producing an article comprising ejecting a liquid through use of the ink jet head of claim 7, wherein the liquid is an ink containing a functional material for forming one of a functional thin film and a functional element.
